(19) United States
(12) Patent Application Publication
(10) Pub. No.: US 2024/0316966 A1
(43) Pub. Date: Sep. 26, 2024

(54) PRINTING UNIT OF AN INKJET PRINTING MACHINE

(71) Applicant: Heidelberger Druckmaschinen AG, Heidelberg (DE)

(72) Inventor: Andreas Müller, Heidelberg (DE)

(21) Appl. No.: 18/610,569

(22) Filed: Mar. 20, 2024

(30) Foreign Application Priority Data
Mar. 23, 2023 (DE) 10 2023 107 312.5

(51) Int. Cl. B41J 25/34; B41J 2/165; B41J 2/21; B41J 25/304

(52) U.S. Cl. CPC B41J 25/34; B41J 2/165; B41J 2/2103; B41J 25/304

(57) ABSTRACT

A printing unit of an inkjet printing machine includes a printing bar with printing heads disposed in a row for printing on a printing substrate, a cleaning device for cleaning the printing heads, a device for individually adjusting the printing heads, at least one respective step-by-step switching mechanism assigned to every printing head, and a common actuator for shifting the step-by-step switching mechanisms of different printing heads. The actuator is movable into positions opposite every step-by-step switching mechanism. The cleaning device is movable and the actuator is disposed on the cleaning device for joint movement so that the actuator can be positioned opposite every step-by-step switching mechanism. It is thus possible to adjust printing heads with great precision while saving time and costs, which is preferably implemented in industrial inkjet printing.

### CROSS-REFERENCE TO RELATED APPLICATION

This application claims the priority, under 35 U.S.C. § 119, of German Patent Application DE 10 2023 107 312.5, filed Mar. 23, 2023; the prior application is herewith incorporated by reference in its entirety.

### FIELD AND BACKGROUND OF THE INVENTION

The invention relates to a printing unit of an inkjet printing machine, including a printing bar with printing heads disposed in a row to print on a printing substrate, a cleaning device for cleaning the printing heads, a device for individually adjusting the printing heads, at least one respective step-by-step switching mechanism assigned to every printing head, and a common actuator for shifting the step-by-step switching mechanisms of different printing heads, the actuator disposed to be movable so as to be positionable in positions opposite every step-by-step switching mechanism.

The technical field of the invention is the field of the graphic industry and in particular the field of industrial, i.e. high-performance inkjet printing on flat substrates, i.e. the application of liquid ink to sheet-shaped, foil-shaped, label-shaped, or web-shaped printing substrates, preferably made of paper, paperboard, cardboard, plastic, metal, or composite materials, in accordance with an image. The application of the ink is achieved by using inkjet printing heads, which need to be adjusted relative to one another in terms of their positions and alignment for high quality printing.

### DESCRIPTION OF THE RELATED ART

German Patent Application DE 10 2016 209 945 A1 discloses a device for adjusting printing heads. For every printing head, the device includes a step-by-step switching mechanism and a movable slide to actuate the step-by-step switching mechanism. The slide is positionable in positions opposite every printing head to be adjusted.

German Patent Application DE 10 2017 215 314 A1 discloses a similar device for adjusting printing heads and a printing unit of that general type, i.e. a printing unit that has the features listed above. For every printing head, the device includes a step-by-step switching mechanism and an actuator disposed on a movable slide to actuate the step-by-step switching mechanism. Through the use of the slide, the actuator is positionable in positions opposite every printing head to be adjusted, where the actuator may be operated pneumatically, for example. The respective step-by-step switching mechanism includes a threaded spindle with a cone which is incrementally rotated in a switching operation by an entrainment lever via gearwheels.

European Patent Application EP 3530473 A1, corresponding to U.S. Pat. No. 10,737,516, discloses a further device for adjusting printing heads. The device includes two step-by-step switching mechanisms for every printing head to be adjusted, i.e. one for every degree of freedom (rotation, translation).

International Publication WO2017/011924A1, corresponding to U.S. Pat. No. 10,457,047, likewise discloses a further device for adjusting printing heads.

In comparison, European Patent Application EP 3527390 B1 discloses a device for adjusting printing heads without tools. The device includes a cone and a head with a ratchet.

International Publication WO2014/160219A1, corresponding to U.S. Pat. No. 9,358,818, discloses an adjustable mount for a printing head. The mount may be clamped by two clamping jaws by using a lever and a thrusting wedge.

The precise adjustment of a high number of printing heads by using a correspondingly high number of adjustment components and drives may be time-consuming and costly in accordance with the number of components and drives to be provided for that purpose.

### SUMMARY OF THE INVENTION

It is accordingly an object of the invention to provide a printing unit of an inkjet printing machine, which overcomes the hereinafore-mentioned disadvantages of the heretofore-known devices of this general type and which provides an improvement over the prior art, in particular by providing a way of adjusting printing heads with great accuracy while keeping the required time and costs low.

With the foregoing and other objects in view there is provided, in accordance with the invention, a printing unit of an inkjet printing machine, including a printing bar with printing heads disposed in a row to print on a printing substrate, a cleaning device for cleaning the printing heads, a device for individually adjusting the printing heads, at least one respective step-by-step switching mechanism assigned to every printing head, and a common actuator for shifting the step-by-step switching mechanisms of different printing heads, the actuator being disposed to be movable so as to be positionable in positions opposite every step-by-step switching mechanism, the cleaning device being disposed to be movable and the actuator being disposed on the cleaning device for joint movement with the latter in such a way that the actuator is thereby positionable in positions opposite every step-by-step switching mechanism.

Advantageous and thus preferred further developments of the invention will become apparent from the dependent claims as well as from the description and drawings.

### Advantageous Embodiments and Effects of the Invention

The invention provides an advantageous way of adjusting printing heads with great accuracy while at the same time keeping the required time and costs low.

The provision of the elongated holes, one of which has a lateral recess, as envisaged by the invention creates a simple technical solution for a step-by-step switch mechanism for adjusting a printing head with a shifting tongue that is movable and operable by an actuator.

### Further Developments of the Invention:

The following paragraphs describe preferred further developments of the invention (in short: further developments).

A further development may be distinguished in that the actuator is operated multiple times to actuate a step-by-step switching mechanism. A further development may be distinguished in that the number of operations is computationally defined and corresponds to an adjustment measure. A further development may be distinguished in that the actuator is operated pneumatically.

A further development may be distinguished in that every step-by-step switching mechanism includes two shifting tongues operable by the actuator to switch the step-by-step switching mechanism in opposite directions. A further development may be distinguished in that the shifting tongues of all step-by-step switching mechanisms are disposed adjacent to one another in a row.

A further development may be distinguished in that two step-by-step switching mechanisms are assigned to every printing head. A further development may be distinguished in that every printing head is assigned a first step switching unit to adjust the printing head relative to an adjacent printing head. A further development may be distinguished in that the first step-by-step switching mechanism adjusts the printing head in a direction transverse to the direction of transport of the printing substrate. A further development may be distinguished in that every printing head is assigned a second step-by-step switching mechanism to adjust the printing head relative to a direction of transport of the printing substrate. A further development may be distinguished in that the second step-by-step switching mechanism adjusts the printing head in terms of its angle relative to the direction of transport of the printing substrate.

A further development may be distinguished in that to apply a multicolor print to a printing substrate, the printing unit includes multiple printing bars with a respective assembly of printing heads disposed in a row together with step-by-step switching mechanisms, and a respective cleaning device disposed to be movable for every printing bar to clean the printing heads and in that a jointly movable actuator for switching the step-by-step switching mechanisms of the respective printing bar is disposed on every cleaning device. A further development may be distinguished in that the cleaning devices are moved together and in that a common drive motor is provided for this purpose. A further development may be distinguished in that multiple actuators of multiple cleaning devices are actuated at the same time and in that in this way multiple step-by-step switching mechanisms of multiple printing bars are actuated at the same time.

A further development may be distinguished in that a plurality of actuators is provided on a cleaning device to simultaneously switch a corresponding plurality of step-by-step switching mechanisms.

Other features which are considered as characteristic for the invention are set forth in the appended claims.

Although the invention is illustrated and described herein as embodied in a printing unit of an inkjet printing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a fragmentary, diagrammatic, perspective view of a preferred exemplary embodiment of a print bar of a printing unit according to the invention;

FIG. 2 is a perspective view of a preferred exemplary embodiment of two step-by-step switches;

FIG. 3 is a side-elevational view of the same preferred exemplary embodiment of two step-by-step switching mechanisms shown in FIG. 2 in an unactuated state;

FIG. 4 is a view similar to FIG. 3 of the two step-by-step switch mechanisms in an actuated state;

FIG. 5 is a fragmentary, side-elevational view of a preferred exemplary embodiment of a shifting tongue;

FIG. 6 is a vertical-sectional view of a preferred exemplary embodiment of a transmission; and

FIG. 7 is a perspective view showing details of a preferred exemplary embodiment of an inkjet printing machine for printing on a printing substrate such as a web of paper.

### DETAILED DESCRIPTION OF THE INVENTION

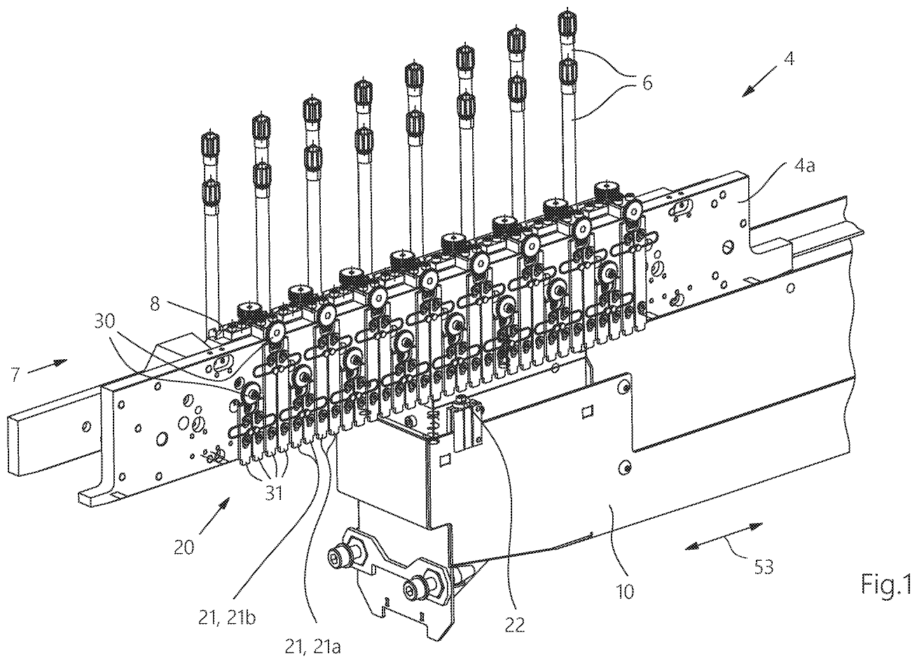

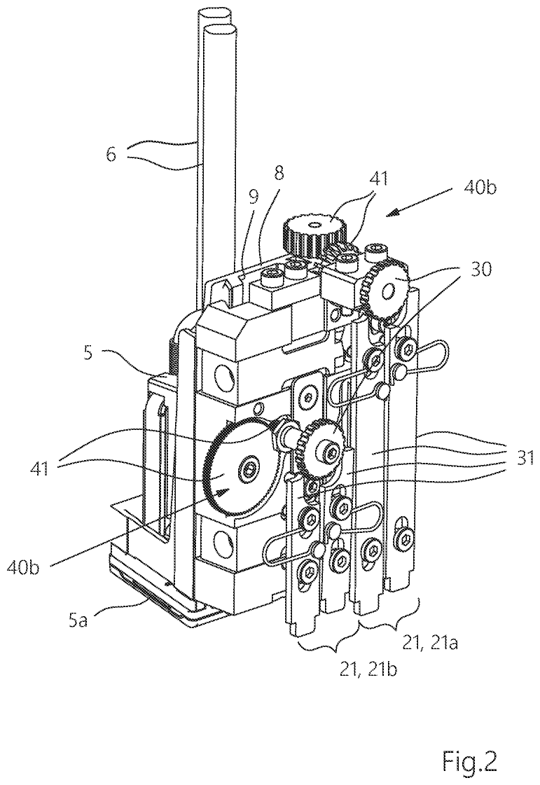

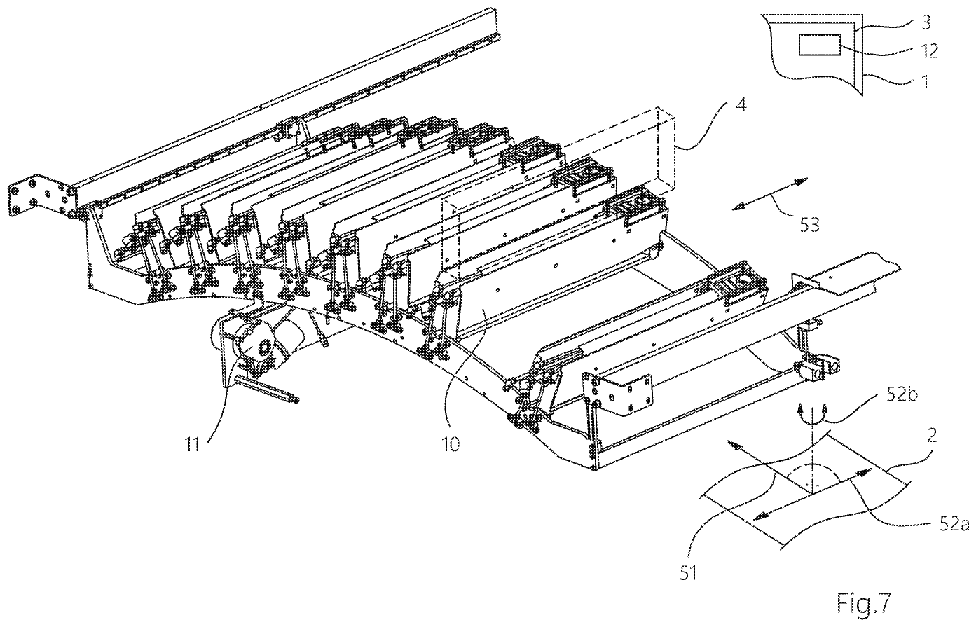

Referring now in detail to the figures of the drawings, in which corresponding features have the same reference symbols and repetitive reference symbols have sometimes been left out for reasons of visibility, and first, particularly, to FIG. 1 thereof, there is seen a perspective view of a preferred exemplary embodiment and of further developments of a print bar of a printing unit of the invention (for instance a printing unit 3 of an inkjet printing machine 1, as seen in FIG. 7). A printing bar 4, which is preferably disposed to be stationary, includes a crossbar 4a. A plurality of neighboring printing heads 5 is disposed in a row 7 on the crossbar. Every printing head is disposed in a respective printing head mount 8 in a guide 9 and includes a nozzle surface 5a (see also FIG. 2, for example). Ink is supplied to the printing heads 5, preferably in a circulatory manner, for instance by using the illustrated lines 6. The inkjet printing machine 1 further includes a computer 12, preferably a digital computer for controlling the adjustment process.

FIG. 1 further illustrates an adjustment device 20 for adjusting/orienting the individual printing heads 5. The adjustment device 20 includes a plurality of step-by-step switching mechanisms 21 disposed adjacent to one another/in a row, each including a first step-by-step switching mechanism 21a and a second step-by-step switching mechanism 21b. FIGS. 2 to 6 illustrate details of the step switching mechanisms or units, which will be explained in more detail in the context of these figures.

(Like every printing bar) the printing bar 4 shown in FIG. 1 is assigned a cleaning device 10 movable back and forth in a direction 53 to clean the printing heads on printing bar 4, which is preferably disposed to be stationary. During a printing operation, the cleaning device 10 is in a stand-by position (illustrated on the right-hand side of FIG. 1). In the cleaning mode, the cleaning device 10 is in a cleaning position (illustrated on the left-hand side in FIG. 1). In the representation of FIG. 1, the cleaning device 10 is in an intermediate position. The cleaning itself is not part of the invention. At least one jointly movable actuator 22, preferably a pneumatically operated actuator, is disposed on the movable cleaning device 10. A drive motor 11 is provided to move the cleaning device(s) 10 (see FIG. 7).

FIG. 2 is a perspective view of a preferred exemplary embodiment of two step-by-step switching mechanisms: namely of a first step-by-step switching mechanism 21a and a second step-by-step switching mechanism 21b. Every one of the two step-by-step switching mechanisms includes an incrementally rotatable locking disk 30. Every one of the two step-by-step switching mechanisms further includes two shifting tongues 31, which are preferably movable in a vertical direction and individually actuatable: namely a first shifting tongue 31a, a second shifting tongue 31b, a third shifting tongue 31c, and a fourth shifting tongue 31d. Transmissions 40a and 40b with gearwheels 41 and/or tapered spindles 42, for example, are assigned to the step-by-step switching mechanisms 31 to translate the respective shifting movement into a corrective movement of the printing heads.

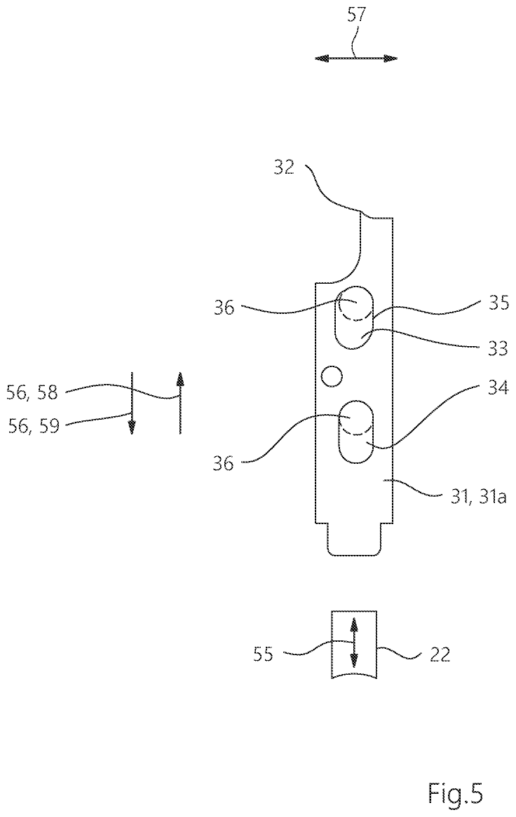

Every shifting tongue 31 preferably includes a protrusion 32 (see FIG. 5), which interacts with the locking disk 30 or rather the locking elements thereof in the shifting operation. Every shifting tongue 31 further includes a first elongated hole 33 and a second elongated hole 34. The first elongated hole 33 (e.g. the upper one) has a lateral recess 35. In cooperation with pins 36, the two elongated holes make the movement possible and limit it at the same time. In an unactuated state, the respective shifting tongues 31 are preferably located in a lower position into which they are pressed by a respective spring element 37. In an actuated state, the respective shifting tongues 31 are preferably in an upper position wherein the locking disk 30 is rotated one locking element further. A pressure element 38 prevents the locking disk 30 from rotating in an undesired way; alternatively, a spring plate may be provided, for instance.

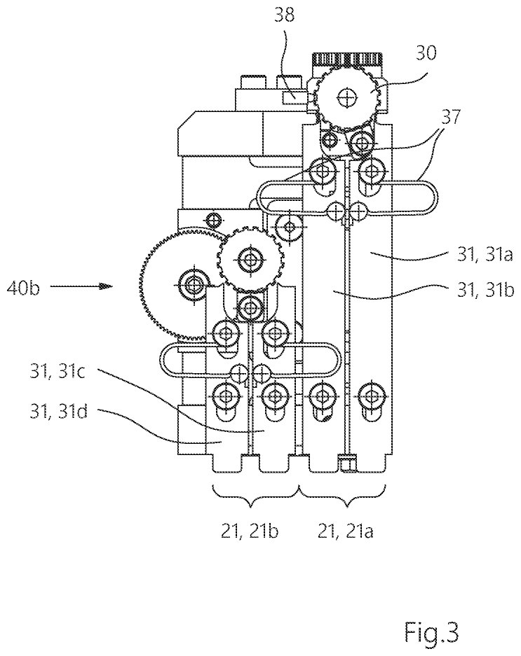

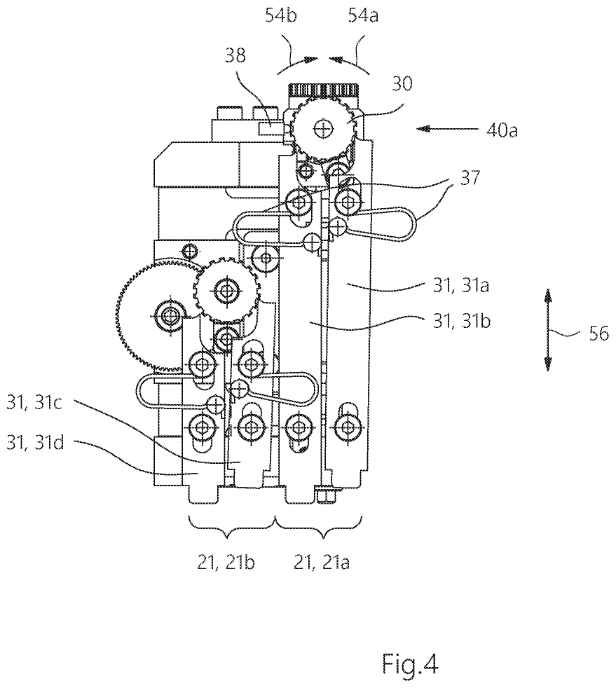

FIG. 3 is a side view of the same preferred exemplary embodiment of two step-by-step switching mechanisms in an unactuated state while FIG. 4 is a side view of the same preferred exemplary embodiment of two step-by-step switching mechanisms in an actuated state. A comparison of FIGS. 3 and 4 reveals that the two actuated shifting tongues 31a and 31c have moved upward/are located in an upper position whereas the two unactuated shifting tongues 31b and 31d are located in a lower position.

FIG. 5 is a side view of a preferred exemplary embodiment of a shifting tongue. For actuating purposes, a change in the position of the cleaning device 10 causes the actuator 22 to move into position, i.e. into a position opposite one of the shifting tongues 31, where it is then preferably actuated by the computer 12 to carry out a movement in a direction 55. In this process, the actuator contacts the respective shifting tongue 31, for example tongue 31a, and moves the latter in accordance with the configuration of the first elongated hole 33 and of the second elongated hole 34. Accordingly, the shifting tongue 31 carries out a movement in a direction 56: either a forward movement 58 (as the shifting movement; in the illustrated example, this is an upward movement) or a return movement 59 (in the illustrated example, this is a downward movement). In the shifting movement, the shifting tongue is capable of carrying out a lateral compensation movement 57 due to the lateral recess 35. When a shifting operation is carried out with shifting tongue 31a, the protrusion 32 preferably rotates the locking disk 30 in a first direction of rotation 54a; in contrast, when a shifting operation is carried out with shifting tongue 31b, the protrusion 32 preferably rotates the locking disk 30 in an opposite, second direction of rotation 54b.

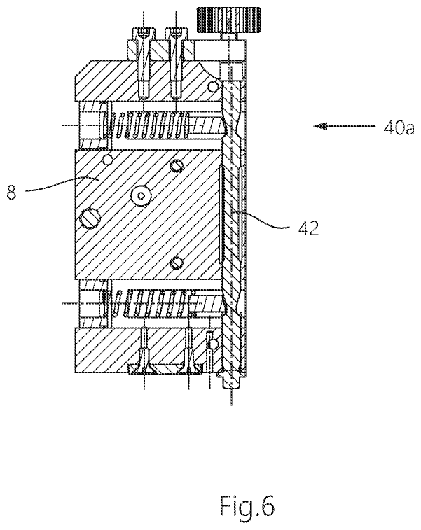

FIG. 6 is a sectional view of a preferred exemplary embodiment of a transmission. The figure shows the tapered spindle 42, which translates the rotary movement provided by the locking disk 30 (and potentially gearwheels connected in between) into a corrective movement of the respective printing head 5/the printing head mount 8 thereof. For this purpose, as shown in FIG. 6, the tapered spindle is moved in a vertical direction due to a rotation thereof. This vertical movement is translated into a horizontal movement of the printing head/printing head mount via a respective cone.

FIG. 7 illustrates details of a preferred exemplary embodiment of an inkjet printing machine 1 for printing on a printing substrate 2 such as a web of paper. The inkjet printing machine 1 preferably includes multiple printing units 3 for printing operations involving multiple colors. Every one of the printing units 3 includes a printing bar 4 (only one of which is shown by way of example) oriented in a transverse direction 52a relative to the direction of transport 51 of the printing substrate and includes printing heads 5. The drive motor 11 causes a horizontal displacement of at least one of the cleaning devices 10 (preferably a joint displacement of all cleaning devices; e.g. by using a common frame) along the printing bars 4 in a direction of movement 53. In this process, the actuator 22 successively reaches positions opposite every step-by-step switching mechanism 21 and may actuate each one as needed, i.e. shift it once or multiple times as a function of the correction requirements. The corrective movement of the respective printing head 5 having a position and/or orientation which requires correction is achieved incrementally/in a step-by-step way (and preferably in micrometer steps) in the transverse direction 52a and/or in terms of its angle 52b relative to the direction of transport 51.

The following is a summary list of reference numerals and the corresponding structure used in the above description of the invention.

### LIST OF REFERENCE SYMBOLS

1 inkjet printing machine
2 printing substrate
3 printing unit
4 printing bar
4a crossbar
5 printing head/printing heads
5a nozzle surface
6 line(s)
7 row
8 printing head mount
9 guide
10 cleaning device
11 drive motor
12 computer
20 adjustment device
21 step-by-step switching mechanism(s)
21a first step-by-step switching mechanism
21b second step-by-step switching mechanism
22 actuator(s) 22
30 locking disk
31 shifting tongues(s)
31a first shifting tongue
31b second shifting tongue
31c third shifting tongue
31d fourth shifting tongue
32 protrusion
33 first elongated hole
34 second elongated hole
35 lateral recess
36 pin(s)
37 spring element
38 block or brake, in particular pressure element
40a transmission
40b transmission
41 gearwheel(s)
42 tapered spindle(s)
51 direction of transport of the printing substrate
52a transverse direction
52b angle
53 direction of movement of the cleaning device
54a first direction of rotation of the locking disk
54b second direction of rotation of the locking disk
55 direction of movement of the actuator
56 direction of movement of the shifting tongue
57 lateral compensation movement
58 forward movement/shifting movement
59 return movement

1. A printing unit of an inkjet printing machine, the printing unit comprising:
a printing bar having printing heads disposed in a row for printing on a printing substrate;
a movable cleaning device for cleaning said printing heads;
a device for individually adjusting said printing heads;
at least one respective step-by-step switching mechanism associated with each of said printing heads; and
an actuator disposed on said cleaning device for joint movement of said actuator and said cleaning device, said actuator configured for shifting said step-by-step switching mechanisms of different printing heads, and said actuator being movable into positions opposite each of said step-by-step switching mechanisms.

2. The printing unit according to claim 1, wherein each of said step-by-step switching mechanisms includes two shifting tongues actuatable by said actuator to shift said step-by-step switching mechanisms in opposite directions.

3. The printing unit according to claim 2, wherein said shifting tongues of all of said step-by-step switching mechanisms are disposed adjacent to one another in a row.

4. The printing unit according to claim 1, wherein each of said printing heads is associated with a respective two of said step-by-step switching mechanisms.

5. The printing unit according to claim 4, wherein each respective one of said printing heads is associated with a first one of said step-by-step switching mechanisms for adjusting said one printing head relative to an adjacent printing head.

6. The printing unit according to claim 5, wherein each respective one of said printing heads is associated with a second one of said step-by-step switching mechanisms for adjusting said one printing head relative to a direction of transport of the printing substrate.

7. The printing unit according to claim 1, wherein:
said printing bar is one of a plurality of printing bars with respective printing heads disposed in a row for applying multiple colors to a printing substrate and with a plurality of said step-by-step switching mechanisms for cleaning said printing heads;
said movable cleaning device is one of a plurality of movable cleaning devices for each of said plurality of printing bars; and
said actuator is one of a plurality of actuators each disposed on and jointly movable with a respective one of said cleaning devices for shifting said plurality of step-by-step switching mechanisms of said respective printing bars.

8. The printing unit according to claim 7, which further comprises a drive motor for moving said cleaning devices together.

9. The printing unit according to claim 7, wherein said plurality of actuators of said plurality of cleaning devices are operated simultaneously for simultaneously shifting said plurality of step-by-step switching mechanisms of said plurality of printing bars.

10. The printing unit according to claim 7, wherein a plurality of said actuators is provided on a respective cleaning device to simultaneously shift a corresponding plurality of said step-by-step switching mechanisms.
